(19) United States
(12) Patent Application Publication
(10) Pub. No.: US 2007/0056425 A1
(43) Pub. Date: Mar. 15, 2007

(54) Link and chain for rock cutting

(76) Inventor: Frank K. Bonar, Pearland, TX (US)

Correspondence Address: Mark R. Wisner;c/o Wisner & Associates, Suite 400, 1177 West Loop South, Houston, TX, 77027, US

(21) Appl. No.: 11/226,986

(22) Filed: Sep. 15, 2005

(51) Int. Cl. B27B 33/14

(52) U.S. Cl. 83/834

(57) ABSTRACT

A link for a trenching apparatus, and an endless chain comprised of repeating sets of links constructed in accordance with the present invention, for efficient and precise trenching operations. The links are pentagonally-shaped in cross section and/or when viewed from the ends, with a top surface that includes a surface that is angled at an angle of between about 105° and about 175° relative to the direction of movement of the links around a chain-milling device. Cutting teeth are mounted in bores in this angled surface and are themselves angled relative to each other and at an angle of slightly greater than 45° relative to the direction of movement of the links when the links are pivotally linked to a plurality of other links to form an endless chain for a chain-milling device and rotated around the chain-milling device. The structure of the teeth and the links are designed to cooperate with each other to increase the durability and penetrating power of the teeth as the teeth encounter rock formations during trenching operations.

### BACKGROUND OF THE INVENTION

The present invention relates to a link for use with a chain-milling or chain-link, conveyor-type cutter, of the type used for cutting rock and other hard soil formations for, for instance, trenching operations for laying cable or pipelines. More specifically, the present invention relates to rock trenchers, the links that comprise the chain-milling cutter of such trenchers, and the mounting of the carbide cutting teeth to such links.

Rock trenchers and cutting machinery are known in the art. Reference is made, for instance, to U.S. Pat. Nos. and 3,954,301 and 4,244,625, as well as underwater trenchers of the type disclosed in U.S. Pat. No. 4,787,777 for descriptions of such machines. Applicant's own published PCT Application No. PCT/US02/28917 also discloses such a machine. Although satisfactory results can be achieved with this prior art cutting machinery in many operating environments, especially the machine disclosed in Applicant's published PCT application, there is room for improvement.

For instance, one of known prior art trenchers is that the cutting chain must be replaced and/or repaired at frequent intervals because the carbide cutting teeth mounted on the links comprising the chain are damaged or even ripped off during trenching operations. There are some rock formations, for instance, that are of such character that they require that the chain be replaced every 40-80 hours of operation. Nor is there any known cutting chain that allows for repair of the chain on the job site; so far as is known, the only way to address the damage to the cutting chain caused by cutting operations is to replace the chain. At a cost of tens of thousands of dollars per chain depending upon the number of teeth and the length and width of the chain, replacement is expensive even before the cost of the time the trencher is out of service is factored into the cost of replacing the cutting chain.

Further, some, usually harder, rock formations can be trenched more efficiently with cutting chains with fewer cutting teeth than are required to trench softer formations or soils efficiently. Although it is not always the rule, it is usually beneficial to use a chain with fewer teeth to cut hard formations so as to concentrate the force exerted on the formation by each tooth, thereby increasing the ability of each tooth to bite, or penetrate, into the rock comprising the formation. So far as is known, no endless chain is available for a chain-milling device that is constructed in a way that allows cutting teeth to be added or subtracted on the job site depending upon the characteristics of the formation or soil that is being cut or trenched. So far as is known, the only way to match a cutting chain to the formation is to switch chains, and of course the disadvantages of switching chains were addressed in the previous paragraph. In actual practice, instead of switching chains depending upon the characteristics of the soil or formation that is being cut or trenched, operators tend to continue operations with reduced cutting efficiency and/or premature wear on the cutting chain, effectively increasing operating costs.

In addition to the disadvantages and limitations of known trenchers summarized in the previous paragraphs, there are limitations relating to the manner in which the teeth are mounted to the links of the endless chain comprising known chain-milling devices. For instance, the cutting teeth of known prior art chains are mounted to the link on a mount that is welded to the generally flat upper surface of the link. Because of the height of the mount and the tooth, the result of this configuration is the creation of a relatively long lever arm. Because of the length of this lever arm, when the tooth encounters a surface that resists penetration during cutting operations, the reactive force tends to cause the tooth to be forced backwardly (in the opposite direction of the movement of the chain), and sometimes the mount for the cutting tooth is even levered off of the surface of the link.

Another disadvantage of conventional links for rock trenchers is that, because of the mounting of the teeth to the flat surface of the links, the spoil that is cut during trenching operations is not moved efficiently out of the cutting path. As a result, the cutting teeth on each successive link of the cutting chain of conventional trenchers tend to encounter the same rocks and spoil that were cut from the formation being trenched by the preceding teeth, reducing cutting efficiency and resulting in increased wear and tear on the cutting teeth.

There is, therefore, a need for a trencher that overcomes the various disadvantages and limitations of known rock trenchers, and particularly, a link for the chains that are used in such trenchers, and it is an object of the present invention to provide apparatus and methods for meeting that need.

More specifically, there is a need for a link that, when linked to other such links into a chain for a chain-milling device, provides more effective cutting of rock and so it is an object of the present invention to provide apparatus and methods for meeting that need.

There is also a need for a link for a chain-milling device to which cutter teeth are moted in such a manner as to hold each cutter tooth in a precise position and cutting angle to the rock face so that each tooth removes a specific area of rock on the cutting face without allowing the tooth to move side to side or around harder spots on the rock face, thereby eliminating, or at least reducing, side loading, vibration, and inefficient cutting operations while forcing the tooth to penetrate into the rock at a precise indicated angle, the angle of the cutter tooth likewise functioning to force the tooth to rotate to keep the tooth sharp, thereby allowing the tooth to penetrate the rock deeper while allowing the tooth to wear evenly, extending tooth life, and so it is an object of the present invention to provide apparatus and methods for meeting that need.

There is also a need to have a continuous tooth arrangement in a cutting pattern so that each tooth mills a path in line and each following tooth has an area to break from the cut area of the first tooth, and then also to provide a backup tooth for each tooth to keep the cutting pattern consistent in the field in the event of a broken tooth during trenching operations to avoid overloading on the next tooth in the pattern, thereby avoiding the breakage of multiple teeth and the loss of the cutting pattern, and so it is an object of the present invention to provide a chain for a chain-milling device for meeting that need.

There is also a need for an apparatus that causes the cutter tooth and link to have an impact on the rock that is more than just the impact that can be created in the conventional manner of increasing the weight and the horsepower of the engine that drives a chain-milling device so as to overcome the hardness of the rock as the link drives the cutter teeth into the rock, and so it is an objection of the present invention to provide a link for a chain for a chain-milling device for meeting that need.

It is also an object of the present invention to provide a cutting chain comprised of a plurality of links having carbide teeth mounted thereto that provides increased chain life and improved cutting capabilities when mounted to a cutter bar and powered by a prime mover for trenching rock formations.

There is also a need for a trencher that provides a relatively uniform size of cuttings for use as padding for a pipeline or other underground conduit, and it is an object of the present invention to provide apparatus and methods for meeting that need.

There is also a need for a chain-milling device that allows the addition or subtraction of carbide cutting teeth depending upon the characteristics of the soil or rock comprising the formation in which trenching or cutting operations are conducted, and more particularly, to be able to add and/or remove teeth from the chain-milling device in the field and without removing the chain from the cutter bar of the trencher, and it is an object of the present invention to provide apparatus and methods for meeting that need.

There is also a need for a mount for the carbide cutting tooth of the links comprising the chain of a chain-milling device that the reduces the height, or extension, of the tooth above the surface of the link so as to reduce the likelihood of damage to the mount and/or the shearing of the tooth off the surface of the link, and it is an object of the present invention to provide apparatus and methods for meeting that need.

There is also a need for a chain for a chain-milling device that is comprised of a repeating set of links with cutting teeth mounted in certain positions on each link in a pattern that minimizes the number of links in the repeating sets of links comprising the chain while maximizing the cutting efficiency of the teeth mounted to the links in the set.

There is also a need for a link that, when linked to other similar links to form the endless chain of a chain-milling device for use in trenching and cutting operations in rock and hard soil, effectively removes the cuttings, or spoil, from the surface of the formation during cutting operations so as to increase the cutting efficiency of the cutting teeth and to decrease wear and tear on the teeth and the links comprising the endless chain.

Other objects, and the advantages, of the link, the cutting chain comprised of such links, the set of links, the cutting chain comprised of sets of such links, the mount for the cutting teeth, the cutting teeth, and the method of the present invention will be made clear to those skilled in the art by the following detailed description of the presently preferred embodiments of these several inventions. It will also be clear from the following detailed description that it is the preferred embodiments of these several inventions that are being described for purposes of exemplifying the invention in accordance with the requirements of the Patent Statute and that there are alternate embodiments of each invention that are not described herein for the purposes of brevity of clarity but that still fall within the spirit of these several inventions and that are intended to be included within the scope of these inventions.

### SUMMARY OF THE INVENTION

These needs are met in the present invention by providing a link for linking to a plurality of similar links to form an endless chain for a chain-milling device comprising a body having leading and trailing surfaces, each of the leading and trailing surfaces being provided with means for pivotally linking the body to the bodies of other similar links to form the endless chain of a chain-milling device. The body is also provided with an upper surface in which a cutting tooth is mounted and a lower surface having means formed therein for engaging the drive wheel of the chain-milling device for moving the body, and the bodies of the similar links to which the body in linked, around the chain-milling device. The leading surface of said body is provided with an upper, angled portion and the cutting tooth is mounted in the upper, angled portion of the leading surface.

Also provided is a link for linking to a plurality of similar links to form an endless chain for a chain-milling device, each link comprising the endless chain having one or more cutting teeth mounted thereto and being comprised of a body having a substantially pentagonal cross-sectional shape. The point and the two arms of the pentagonally-shaped body form a leading surface, the base of the pentagon forms a trailing surface, and one side of the pentagon is provided with means formed therein for engaging the drive wheel of the chain-milling device for moving the body, and the bodies of the links to which the body is linked, around the chain-milling device. The other side and one of the arms of the pentagonally-shaped body form a top surface for mounting a cutting tooth thereto.

Also provided is an endless chain for a chain-milling device comprising a plurality of sets of links, each link comprising the set of links being pivotally linked to an adjacent link, the top surface of each link being comprised of a surface oriented at an angle relative to the direction of movement of the endless chain when mounted on a chain-milling device, at least two of the links comprising each set of links having four bores on the angled surface thereof for receiving a cutting tooth therein, at least one of the links comprising each set of links having four bores spaced approximately equidistant across the angled surface thereof for receiving a cutting tooth therein, at least two of the links comprising each set of links having three bores on the angled surface thereof for receiving a cutting tooth therein, at least one of the links comprising each set of links having three bores on the angled surface thereof with two of the bores being proximate the ends of the links and oriented at an angle extending outwardly therefrom for receiving a cutting tooth therein, at least two of the links comprising each set of links having two bores on the angled surface thereof for receiving a cutting tooth therein, and at least one of the links comprising each set of links having two bores spaced approximately equidistant across the angled surface thereof for receiving a cutting tooth therein.

Also provided is an endless chain for a chain-milling device comprising a plurality of sets of links, each link being pivotally linked to an adjacent link to form an endless chain for movement around the chain-milling device, each set of links being comprised of:
at least two A links, each A link having four bores on the angled surface thereof for receiving a cutting tooth therein;
at least one B link having four bores spaced approximately equidistant across the angled surface thereof for receiving a cutting tooth therein;
at least two C links, each C link having three bores on the angled surface thereof for receiving a cutting tooth therein;
at least one D link having three bores on the angled surface thereof, two of the bores being proximate the ends of the D link and oriented at an angle extending outwardly therefrom, for receiving a cutting tooth therein;
at least two E links, each E link having two bores on the angled surface thereof for receiving a cutting tooth therein; and
at least one F link having two bores spaced approximately equidistant across the angled surface thereof for receiving a cutting tooth therein.

In another aspect, the present invention provides a method of maximizing the efficiency of cutting operations of a chain-milling device comprised of an endless chain having cutting teeth mounted to one or more of the links comprising the endless chain that is rotated around the chain-milling device by an engine comprising the steps of stopping the rotation of the endless chain around the chain-milling device, and after the chain is stopped, either adding or subtracting cutting teeth by inserting or removing cutting teeth from bores in the links comprising the endless chain without removing the endless chain from the chain-milling device. After adding or removing cutting teeth from the endless chain, the endless chain is again rotated around the chain-milling device.

### BRIEF DESCRIPTION OF THE DRAWINGS

FIG. 1 is a perspective view of a rock trenching machine constructed in accordance with the teachings of the present invention having the endless chain comprising a portion of the chain-milling device, or cutter bar, removed therefrom for purposes of clarity.

FIG. 2 is a side, elevational view of a portion of the rock trencher of FIG. 1.

FIGS. 3A-3D are end elevational (FIG. 3A), perspective (FIG. 3B), side elevational (FIG. 3C), and sectional (FIG. 3D) views (the sectional view shown in FIG. 3D being taken along the lines A-A in FIG. 3A) of a link for a chain-milling device constructed in accordance with the teachings of the present invention.

FIGS. 4A-4C are top, plan (FIG. 4A), side elevational (FIG. 4B), and end elevational (FIG. 4C) views of a portion of an endless chain comprised of the links of FIG. 3.

FIG. 5 is a side elevational view of a tooth constructed in accordance with the teachings of the present invention for mounting to the link of FIG. 3.

### DETAILED DESCRIPTION OF THE PREFERRED EMBODIMENTS

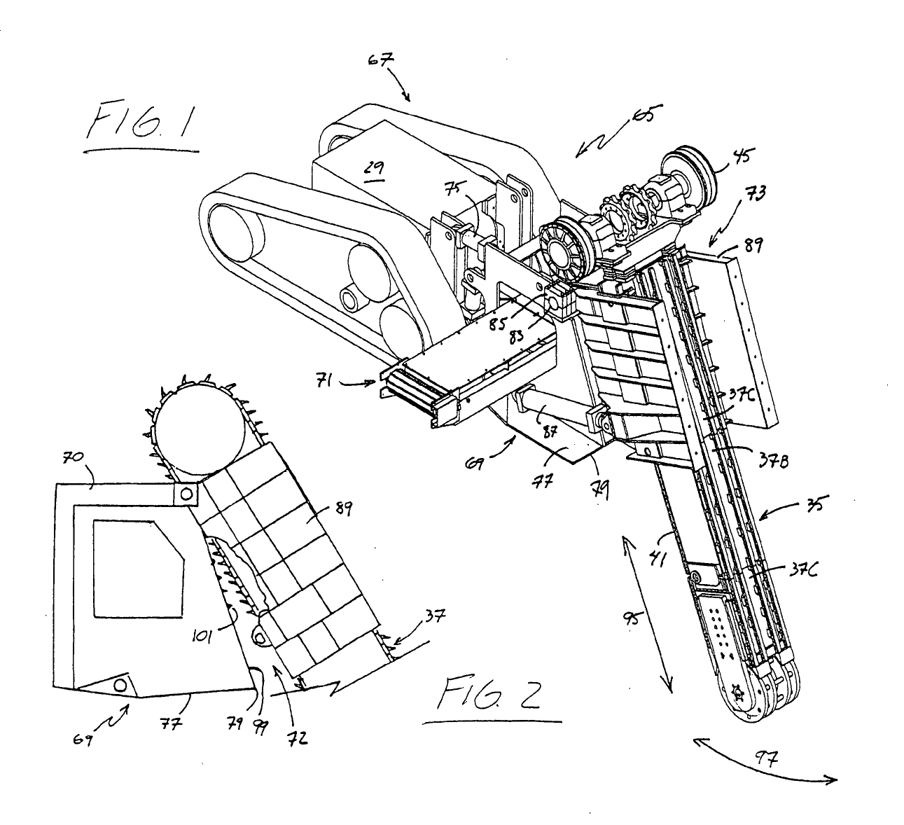

Referring now to the figures, a rock trencher having a chain-milling device 35 mounted thereto that is provided with links constructed in accordance with the teachings of the present invention is indicated generally at reference numeral 65 in FIGS. 1-2. Trenching apparatus 65 is comprised of a vehicle 67 to which a chain-milling device 35 is mounted that is powered by an engine that is contained within the housing shown at reference numeral 29. In the embodiment shown, chain-milling device 35 is not mounted directly to vehicle 67; instead, chain-milling device 35 is mounted to a sled 69 that is pivotally mounted to vehicle 67. Sled 69 is comprised of a frame 70 that is adapted for mounting a conveyor 71 and a tool bar assembly 73 thereto as best shown in FIG. 1. Although not an essential element of such a trencher, in the embodiment shown in FIGS. 1-2, a conveyor 71 is mounted to the frame 70 of sled 69 on a rail (not visible in the figures) to allow the conveyor to slide from side-to-side under control of a double-acting hydraulic cylinder (also not visible). In this manner, the spoil that is pulled up from the trench by chain-milling device 35 is deposited either immediately adjacent the trench or at a distance from the edge of the trench, as may be desired, and on either side of the trench. Further control of the spoil is achieved by using a variable speed hydraulic motor (also not visible in the figures) for powering the conveyor, operation of the motor at higher speeds having the result of spreading, or throwing, the spoil to one side or the other of the trench.

Those skilled in the art who have the benefit of this disclosure will recognize from this description of the apparatus 65 that the sled 69 is not required for the apparatus 65 to function for its intended purpose and that the chain-milling device 35 may also be mounted directly to vehicle 67 in the manner as known in the art. However, when mounted with the contact plate 77 positioned adjacent the surface of the ground to be trenched, sled 69 does serve several functions as described below and therefore comprises a significant improvement over prior art trenching apparatus.

Although the pivot point is not visible in the view shown in FIG. 1, it will be apparent from the location of the hydraulic cylinders 75 (only one of which is shown for purposes of clarity) that sled 69 pivots relative to vehicle 67 to continually force the contact plate 77 that is integral with the frame 70 of sled 69 against the surface of the ground that is being trenched as the pitch and attitude of vehicle 67 changes as it advances across the surface of the ground that is being trenched. The pivoting of sled 69 relative to vehicle 67 is accomplished by continually sensing the pressure in the hydraulic lines (not shown), comparing that pressure to a pre-selected set pressure, and adjusting the extension of the rams comprising hydraulic cylinders 75 to force the contact plate 77 against the surface of the ground that is being trenched. This continual forcing of the contact plate 77 of sled 69 against the surface of the ground being trenched serves the function of reacting the upward force resulting from operation of chain-milling device 35. In other words, as the chain-milling device 35 bears against the strata in which the trench is being laid out, the strata is ripped and torn out of the trench and the spoil from that ripping action is carried upwardly by chain tool 37. This upwardly-acting force has the result of causing the strata to be ripped out of the trench pieces, with considerable, almost instantaneous, variations in force on the endless chain 33 comprising chain tool 37 such that chain 33 is continually being subjected to violent changes in force in many different directions during operation of the chain-milling device 35. The result of these continuous changes is continual vibration in the apparatus 65. Continual downward forcing of contact plate 77 against the surface of the ground that is being trenched by action of the hydraulic cylinders 75 (under control of the above-described hydraulic pressure monitoring system) reacts the upwardly-acting force of the chain tool 37. As a result of the reaction of the upwardly-directed force from chain tool 37 by contact plate 77, chain tool 37 is able to cut the trench in a more controlled fashion, and vibration and wear on the chain comprising chain tool 37, as well as the other components of apparatus 65 are decreased, thereby significantly prolonging the life of the chain and decreasing maintenance costs for the entire apparatus 65.

Those skilled in the art who have the benefit of this disclosure will recognize that, by the use of the term “continuous” in the previous paragraph, it is not intended that the hydraulic pressure of hydraulic cylinders 75 must be changing at all times for the cylinders 75 to be effective in forcing the contact plate 77 downwardly against the surface of the ground through which the apparatus 65 is trenching. The term “continuous,” when used in reference to the downward forcing of contact plate 77 against the surface of the ground, is instead intended to convey the concept of changing the hydraulic pressure to hydraulic cylinders 75 to change the angle of sled 69 relative to vehicle 67 so as to push contact plate 77 against the ground during trenching operations as necessary in such a way as to react some or all of the upwardly-directed force of the teeth mounted on the chain 33 of chain tool 37 as the teeth bear against a stratum (or strata) comprising a formation in the ground to be trenched.

An unanticipated benefit of forcing the contact plate 77 against the surface of the ground to be trenched to react the upwardly-directed force created by the ripping action of the teeth of chain tool 37 against the stratum/strata being trenched was the discovery that the leading edge 79 of contact plate 77 acts as a bearing, or crush, point against which the spoil, or cuttings, from the stratum/strata engaged by the teeth (not shown) comprising the chain 33 of chain tool 37 bears as the spoil works its way up out of the cut during rotation of chain 33 around chaing tool 37. As a result of this crush point provided by the leading edge 79 of contact plate 77, the effective force brought to bear against the strata comprising the ground to be trenched is increased such that the apparatus 65 is able to trench at faster speeds and through harder rock formations than previous known trenching apparatus while reducing the rock fragments in the spoil to smaller pieces as they contact the crush point so that the teeth mounted on the chain of chain tool 37 can mill the fragments into smaller pieces instead of larger, unmanageable chunks. As might be expected, the leading edge 79 of contact plate 77 is subjected to severe forces as a result of its function as a crush point and, for this reason, in one embodiment, the contact point, or at least the leading edge 79 and the portion of contact plate 77 adjacent the trailing edge, is comprised of a hardened, impact resistant material for increased durability.

As best shown in FIG. 1, the tool bar assembly 73 comprising a portion of the sled 69 is pivotally mounted to sled 69 on the pivot axis 83 and bushings 85. Referring to FIG. 1, it can be seen that tool bar assembly 73 is pivoted relative to sled 69 by hydraulic cylinders 87 that are mounted to sled 69 for a purpose to be described below.

Tool bar assembly 73 is provided with a pair of opposed side plates 89 having tracks 91 formed therein (see FIG. 2) for receiving complementary-shaped rails 92 integral with chain-milling device 35. Although only the butt plates 93 to which they are mounted are visible in the figures (see FIG. 2), hydraulic cylinders are mounted between the chain-milling device 35 and tool bar assembly 73 for slidably moving the chain-milling device 35 up and down relative to vehicle 67. By action of hydraulic cylinders 87 and the hydraulic cylinders mounted in the tracks 91, the cutting angle of chain-milling device 35 (shown by the arrow 97 in FIG. 5) and the depth of cut (arrow 95) of chain-milling device 35 are changed either by operator intervention and/or by continuous adjustment as a result of the monitoring of the hydraulic pressure in the various lines in the manner described above. The ability to change the cutting angle of chain-milling device 35 and the ability to move the chain-milling device 35 up and down relative to vehicle 67 also provides the trenching apparatus 65 with the unique operating capability of “rocking” the chain-milling device 35 to concentrate cutting power on a particular difficult stratum/strata in a manner similar to the way that a carpenter rocks a handsaw to concentrate the cutting force of the saw on wood as it is sawn. This rocking function can be accomplished under operator control using the above-described means for changing the depth of cut and/or the angle of chain-milling device 35 or by programmed operation that is activated either by the operator or automatically when sensed changes in the hydraulic pressure to the hydraulic cylinders 75 and 87 exceed a preselected degree of change, indicative of a particularly hard stratum or strata that has been encountered by chain-milling device 35. As best shown in FIG. 1, it can also be seen that the chain tool 37 comprising chain-milling device 35 is comprised of three sections 37A, 37B, and 37C, and that the depth of cut of the trench can also be adjusted by changing the length of the chain tool 37 by inserting one or more center sections 37B (only one such section being shown in FIG. 1) or removing the center section 37B.

As the chain tool 37 cuts the stratum/strata through which a trench is being cut, the spoil that is ripped upwardly and crushed or sheared against the trailing edge 79 of contact plate 77 is carried upwardly along the length of the lower deflection area 41 of chain-milling device 35 into the area between the sled 69 and the chain-milling device 35. Because the tool bar assembly 73 to which chain-milling device 35 is mounted is pivotally mounted to sled 69 on the pivot axis 83 and bearings 85 above the frame 70 of sled 69, the chain tool 37 and the front of sled 69 are not parallel to each other. Instead, the space between the chain-milling device 35 and the front of sled 69 decreases at points closer to pivot axis 83. As spoil is carried upwardly to drop onto conveyor 71, this decrease in the space between chain-milling device 35 and sled 69, indicated by the arrow 72 in FIG. 8, acts to further crush the spoil. To maximize the crushing action of this decrease in the space 72 between sled 69 and chain tool 37 as the spoil is carried upwardly toward the pivot axis 83, the front of sled 69 is provided with a hardened face, or anvil, 99 that is provided with one or more ridges 101, each of which act to provide further crush points as the spoil is swept further upwardly along the anvil 99. In another embodiment (not shown), the ability of the sled 69 to process the rock spoil cut from the ground to be trenched by chain-milling device 35 is enhanced by mounting a second conveyor to the sled 69 to catch the spoil as it falls off of conveyor 71, the second conveyor being provided with a screen having a mesh size selected for separating the milled rock spoil into particles of sizes suitable for padding and back-filling the trench after the cable and/or pipe is laid therein and depositing the processed, separated rock spoil in parallel rows along the trench as the vehicle to which the sled 69 is mounted progresses along the intended path. If necessary, a vibratory shaker may be added to this second conveyor for insuring that the material is moved and separated as desired.

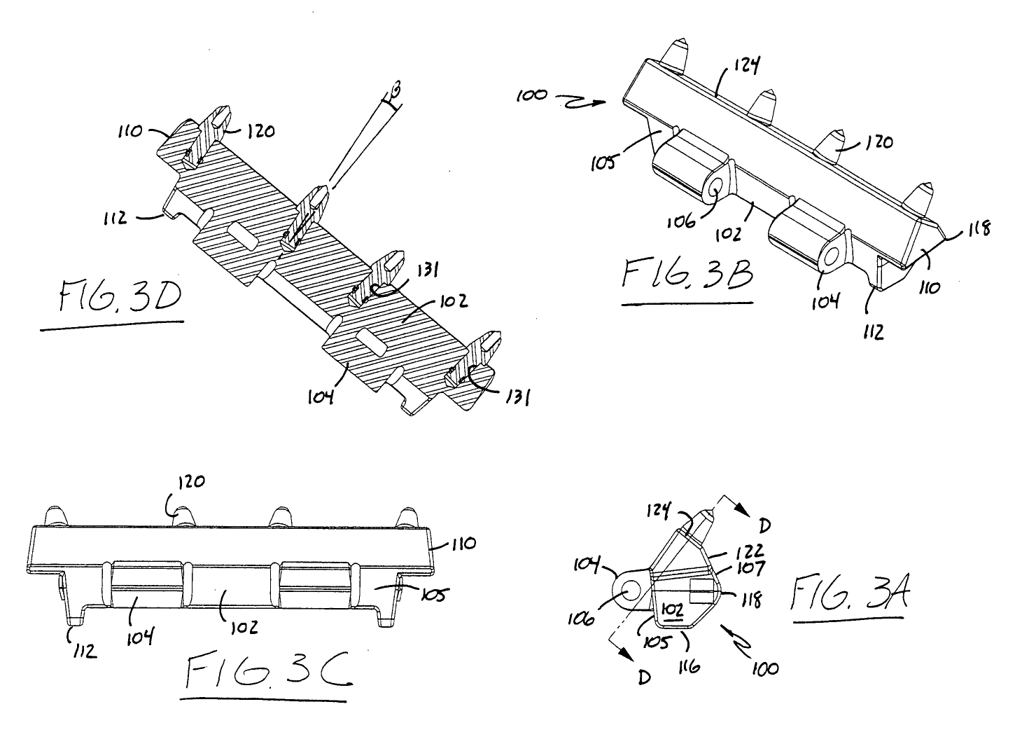

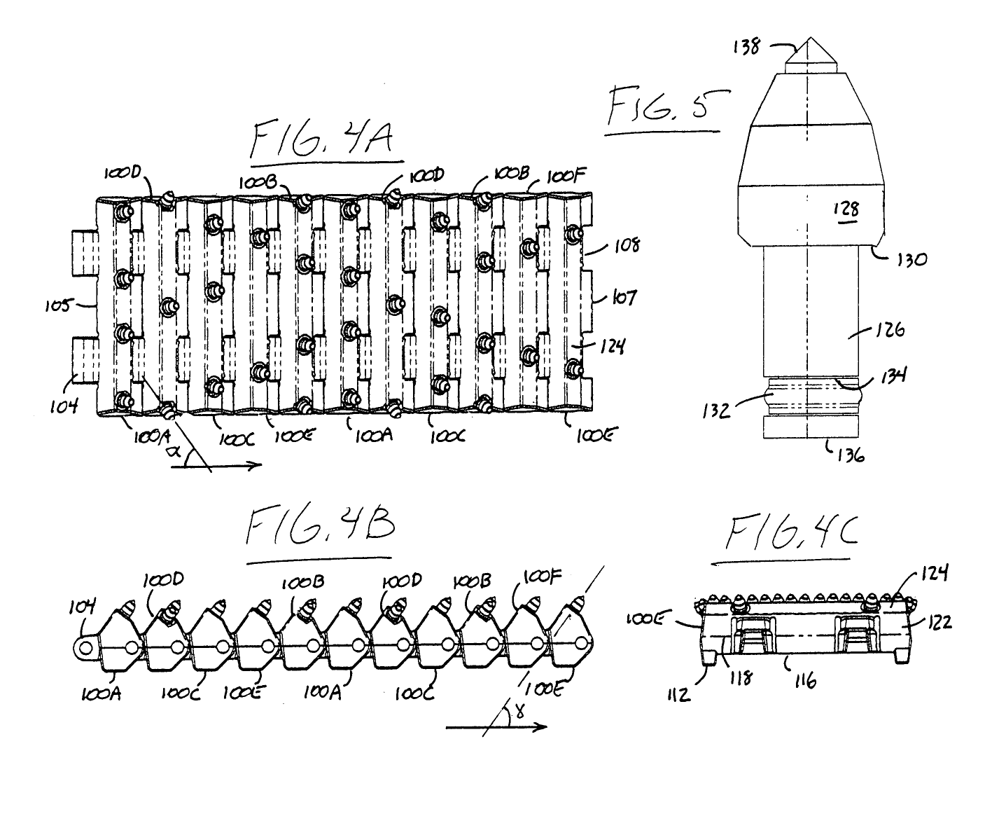

A link constructed in accordance with the present invention for linking to other similar links to make up the chain 33 of chain-milling tool 37 is indicated generally at reference numeral 100 in FIGS. 3A-3D. Link 100 is comprised of a body 102 having two projections 104 on the trailing surface 105 of the link 100 with bores 106 through each projection 104 for receiving a pin (not shown) for assembling the body of link 100 to an adjacent link (see FIGS. 4A and 4B) in the manner known in the art, complementary recesses 108 on the leading surface 107 of each link 100 for receiving the projections from the trailing surface of the body of an adjacent link for assembly of the endless chain 33, and flanges 112 adjacent the ends 114.

The flanges 112 at the ends 110 of body 102 overhang the edges of the skid plates 39 comprising chain tool 37 (FIG. 1) so that the skid plates 39 act as a rail to guide each link 100 of chain 110 as the underside 114 of body 102 slides along the length of chain tool 37. In this manner, the flanges 112 resist the tendency of the body 102 to move in a direction other than the direction of movement when the body 102 of link 100 is linked to the bodies of other links to form the endless chain 33 of chain-milling device 35 and moved, or rotated, around the chain-milling device. The “racking” of the link from side-to-side as a cutting tooth encounters a particularly hard rock or portion of a formation being cut and momentarily resists movement in the direction of the movement of the links around the cutting tool causes additional wear and tear on the cutting chain of conventional chain-milling devices, and the resistance to this racking of the link provided by the guiding of the link along the skid plates 39 of cutting tool 37 that is accomplished by these flanges 112 helps reduce wear and tear on the cutting chain 33 comprised of the links 100 of the present invention.

As shown in FIG. 3A, the body 102 of link 100 is substantially pentagonally-shaped when viewed from the end, or in cross section, with the widest portion of the pentagon being forming a spine 118 on the leading edge 107 of each link 100 to provide structural rigidity to resist forces exerted on the link 100 by impact of the carbide cutting teeth 120 mounted to link 100 against rock (not shown) during rotation of the endless chain 110 around the chain-milling device 35. Stated another way, the point, or spine, 118 and the two arms of the pentagon form the leading surface 107 of body 102 and the base of the pentagon forms the trailing surface 105 of body 102. One side of the pentagonally-shaped body 102 is provided with means formed on the underside 116 for engaging the drive wheel 45 of chain-milling device 35 for moving body 102, and the bodies of the links to which body 102 is linked to form endless chain 33, around chain-milling device 35 and the other side and one of the arms of the pentagon forms a top surface for mounting a cutting tooth 120 thereto. In addition to the point, or spine 118, the leading surface 107 of link 100 is comprised of a forward-facing surface 122 and a surface 124 that is oriented at an angle of approximately 135° relative to the direction of travel of the link 100 as the endless chain 33 is rotated (the direction of movement of each link 100 is shown by arrow 101 in FIGS. 4A and 4B). The angled surface 124 of body 102 provides two functions, the first as a surface for mounting the teeth 120 therein and the second function is to provide a surface that contacts and pushes the cuttings, or spoil, from the rock that is being trenched upwardly out of the trench and into contact with the anvil 99 described above (see FIGS. 1 and 2). Although the angled surface 124 is described herein as being angled at approximately 135° relative to the direction of travel of link 100 as the endless chain 33 is rotated around chain-milling device 35, those skilled in the art who have the benefit of this disclosure will recognize that the surface 124 will function for its intended purpose when angled at any angle (or at different angles in different links 100) from about 100° to about 175° relative to the direction of movement of link 100.

Referring now to FIG. 5, a carbide cutting tooth 120 for mounting to the body 102 of the link 100 of the present invention is shown in detail. Tooth 120 is comprised of an elongate shank 126 and head 128, the shoulder, or step-down, 130 between the two component parts forming a surface for prying the tooth 120 from the bore 131 (FIG. 3D) in which it is received to mount tooth 120 to the angled surface 124 of body 102 in the manner described below. A snap ring 132 resides in a complimentary-shaped annular groove 134 near the base 136 of shank 126 for retaining tooth 120 in the bore in the manner known in the art.

As shown by comparison of FIGS. 3A and 3D, the bore 131 in which tooth 120 is received is formed in the angled surface 124 of the body 102 of link 100. Location of the bore 131 in the angled surface 124 and mounting of tooth 120 by receipt of the shank 126 in the bore 131 confers several advantages upon the link of the present invention. For instance, the metal comprising the body 102 of link 100 confines the shank 126 within bore 131, effectively reinforcing the shank 126 against bending, or even breakage, by impact of the tooth on a particularly hard underground formation. Further, the driving of the shoulder 130 against the angled surface 124 upon impact of the carbide tip 138 against the rock formation being trenched, made possible by the angle of angled surface 124, transfers some of the load to which tooth 120 is subjected from tooth 120 to the link 100, effectively increasing the durability of tooth 120. Perhaps most importantly, the height that the tooth 120 extends out away from the surface to which it is mounted is greatly reduced as compared to the height of the cutting teeth mounted to prior known links for such chain-milling devices, thereby decreasing the length of the lever arm created by impact of the tooth against a rock so as to decrease the likelihood that the tooth will be sheared off of the link. This reduction in the height of the tooth likewise decreases the likelihood of damage to the mount of the tooth as compared to prior known links for chain-milling devices.

To maximize these benefits of the link of the present invention, in a preferred embodiment, tooth 120 is sized and dimensioned to cooperate with the structure of the link 100 of the present invention. Specifically, the length of shank 126 and the depth of the bore 131 are dimensioned so that the base 136 of shank 126 does not contact the bottom of the bore 131 in the body 102 even when the carbide tip 138 encounters a hard rock formation with the result that tooth 120 is driven into the surface 124 of the body 102 of link 100. In this manner, any likelihood of a bending moment in the shank 126 resulting from such impact is effectively eliminated. Further, the ratio of the diameter of the head 128 tooth 120 to the diameter of the shank 126 is fixed within a range that creates a shoulder 130 of a certain dimension that effectively transfers the load of any such impact from the tooth 120 to the angled surface 124 of the body 102 of link 100. In the preferred embodiment, the ratio of these two diameters is approximately 1.5 to 1 (head to shank), but ratios ranging from about 1.3 to 1 up to about 2.0 (and even higher) to 1 have been shown to accomplish satisfactory results (so far as is known, there is no upper limit to this ratio other than the limits imposed by practicality and economics). It has also been discovered that improved results are attained by dimensioning the length of shank 126, in addition to being dimensioned so as to cooperate with the depth of the bore 131 in the body 102 of link 100, relative to the length of the head 128 of tooth 120. In other words, if the length of the head 128 is too long relative to the length of the shaft 126, the tooth 120 does not provide optimal cooperation with the body 102 of link 100 and therefore is not capable of bearing as much load. To maximize the cooperation between tooth 120 and link 100, the length of the shaft 126 of tooth 120 is dimensioned so as to range in length from a ratio of about 0.8 to 1 (length of shaft to length of head) up to about 1.5 to 1, and preferably approximately 1.1 to 1.

Referring now to FIGS. 4A-4C, a portion of an endless chain 33 for a chain-milling device constructed in accordance with the present invention is shown. Endless chain 33 comprises a plurality of sets (one such set being shown in FIGS. 4A and 4B) of eleven links 102 each, each link 102 comprising each set of links being pivotally linked to an adjacent link 102. The top surface of each link 102 is comprised of the surface 124 described above that is oriented at an angle relative to the direction of movement shown by arrow 101 (FIGS. 4A and 4B) of endless chain 33 when mounted to chain-milling device 35, and each set of eleven links is comprised of one or more links 100 of seven configurations as follows (those skilled in the art will recognize from this description of the set of links that the set may include one, two, or more of each type of link comprising the set of links such that it will be understood that when a set of links is described as being comprised of one, two, or more of each type of link, it is actually being described as being comprised of “at least one,” “at least two,” etc. such links):
two links designated by the letter A in FIG. 4A, each A link having four bores 131 on the angled surface 124 thereof for receiving cutting teeth 120 therein;
one link designated by the letter B in FIG. 4A having four bores 131 spaced approximately equidistant across the angled surface 124 thereof for receiving cutting teeth 120 therein;
two links designated by the letter C in FIG. 4A, each C link having three bores 131 on the angled surface 124 thereof for receiving cutting teeth 120 therein;
one link designated by the letter D in FIG. 4A, each D link having three bores 131 on the angled surface 124 thereof, two of the bores 131 being proximate the ends 110 of the D link and oriented at an angle extending outwardly from the ends 110 of the D link, for receiving cutting teeth 120 therein;
two links designated by the letter E in FIG. 4A, each E link having two bores 131 on the angled surface 124 thereof for receiving cutting teeth 120 therein; and
one link designated by the letter F in FIG. 4A, each F link having two bores 131 spaced approximately equidistant across the angled surface 124 thereof for receiving cutting teeth 120 therein.

It has been found that when the cutting teeth 120 are mounted to links 100A-100F in this configuration and multiple sets of eleven such links are assembled to each other and rotated around a chain-milling device such as is shown at reference numeral 37 in FIGS. 1 and 2, trenching operations are conducted with increased efficiency and with decreased wear on the teeth comprising the endless chain 33 and on the links 100 comprising that chain. By viewing the set of links 100A-100F from the end as shown in FIG. 4C, it can be seen that this arrangement of the teeth 120 across the width of the bodies 102 of links 100 provides effective coverage across the width of the links 100 in that every tooth 100 overlaps with another tooth across that width.

By comparison of links 100B and 100D, it can be seen that the cutting teeth 120 mounted proximate the ends 100 of the body 102 of link 100D are oriented at an angle extending outwardly from the ends 110. This outward angling of the teeth mounted in link 100D at an angle of about 25° to about 75°, and preferably between about 45° and 55°, is shown in FIG. 4A and is designated as angle α, and has been shown to provide a cleaner edge to the cut and better penetrating power in the rock at the edge of the cut in the formation as the chain-milling device 35 engages the formation to be cut or trenched, thereby increasing the efficiency of cutting operations and decreasing the wear on the chain 33. By looking at the ends 110 of the chain 33 comprised of links 100A-100F in FIG. 4C, it can be seen that the angle a may be different from link to link. FIG. 4A shows that outwardly angled teeth 120 are mounted to both links 100B and 100D and, as seen in FIG. 4C, the outward angle a of the teeth 120 mounted to links 100B is different than the outward angle α of the teeth 120 mounted to links 100D (although not as apparent, the different angles α are also shown in FIG. 4A).

By reference to FIGS. 3C and 3D, it can also be seen that the bores 131 in which teeth 120 are mounted are angled relative to one another and relative to the direction of movement of the links 100 on chain-milling device 35. This angle β is shown in FIG. 3D and is an angle that is an angle other than 90° relative to the angled surface 124 of the body 102 of link 100; in other words, the longitudinal axis of cutting teeth 120 is not perpendicular to the surface 124. This angle β insures that the teeth 120 rotate in the bores 131 as they engage the formation to be trenched so as to self-sharpen, and optimally ranges between about 3° and about 15° off of perpendicular, preferably about 6° to about 9° off of perpendicular, to the angled surface 124.

By reference to FIG. 4B, it can also be seen that the teeth 120 are oriented at an angle, designated angle γ, relative to the direction of movement 101 of the links 100 comprising endless chain 33 that is slightly greater than 45° relative to the direction of movement of links 100. This angle γ is referred to as an angle that ranges from a negative 48° to a negative 67°, and preferably from about negative 50° to about negative 55°, because it describes the angle of attack of the teeth 120 on the rock comprising the formation to be trenched or cut. In other words, because normal cutting operations are conducted with the chain tool 37 oriented at a nominal angle of approximately 45° relative to the surface of the formation on which the trencher 67 rests, the angle γ is slightly greater than 45° relative to the direction of movement 101 of the links 100 around the chain-milling tool 35 so that the teeth are oriented at an angle greater than about 90° relative to the surface of the formation (the surface of the formation against which the teeth bear may be referred to as “the point of attack”). Because the chain tool 37 is angled downwardly and the teeth 120 are therefore angled back upwardly, the angle γ is referred to as a “negative” angle. To summarize, the teeth 120 are mounted in the bodies 102 of links 100 in bores 131 that are angled so that the teeth are angled relative to each other (see angle β in FIG. 3D) and relative to the point of attack (see angle γ in FIG. 4B)

Some of the advantages of making up the endless chain 33 with a plurality of sets of links 100A-100F will be apparent from the following explanation. Upon encountering hard formations, it has been found advantageous to reduce the number of teeth 120 on endless chain 33, thereby concentrating the penetrating force exerted upon the formation by each tooth mounted on the chain at the point of attack. The arrangement of the teeth 120 on the links 100A-100F in a repeating pattern every eleven links is such that teeth can be removed from the bores 131 in links 100A-100F without compromising the full coverage of the teeth across the link, e.g., without leaving a portion of the trench cut by chain-milling device 35 without teeth. Unlike conventional endless chains, the teeth 120 are removed from the bores 131 in links 100A-100F by prying them from the bores and the link is not left with a mount that is welded to the link that could be damaged by operation of the chain-milling device without a tooth in each mount. Applicant has found that there is a mathematical relationship between the number of teeth 120 and the horsepower of the engine (under the engine cover 29 in FIG. 1) that moves the chain 33 around chain-milling device 35 that limits the number of teeth that can be removed from chain 33 for the purpose of concentrating the penetrating force in hard formations, however. Specifically, depending upon the materials comprising the teeth 120, the number of teeth that are removed from chain 33 should not exceed the number that will increase the ratio of the horsepower of the engine to the number of teeth above a range of from about 45 to 1 (horsepower to each tooth) to about 100 to 1, and preferably about 75 or 90 horsepower per tooth. Also as a result of the negative angle at which the cutter teeth 120 are mounted to link 100 and the strength and rigidity of link 100 as provided by its pentagonal cross-sectional shape, the link provides a minimum of about 40 pounds of driving weight on each tooth in endless chain 33 while the chain rotates around chain-milling device 35 at a speed of about 400 to about 500 feet per minute (those skilled in the art will recognize that the driving weight of each tooth will vary in accordance with a number of factors such as the speed at which the link is rotated around the chain-milling device, the mass of the link, the angle of attack and the angle at which the tooth is mounted to the link, the horsepower and torque provided by the engine, the weight of the vehicle and the chain-milling device, the force exerted by the hydraulic cylinders 77, and many other factors such that the driving weight and the speed set out herein are but examples of these operating parameters and are not to be considered essential for the satisfactory operation of the chain-milling device described herein).

By adjusting the number of teeth on the chain 33 using this mathematical formula and the position of the teeth on the links 100A-100F, it has been discovered that efficient trenching operations can be conducted in a wide range of soils and formations, including some formations that could not be successfully trenched using prior known trenchers. By removing teeth in hard rock, adding teeth in soft rock or soil, re-positioning teeth on the links for soils and/or rock of different characters, and adding or removing the teeth extending at an outward angle proximate the ends 110 of links 100B and 100D, precise and efficient cutting has been achieved in every formation in which the chain of the present invention has been tested. Unprecedented results have even been achieved in certain formations such as granite and basalt. Perhaps most impressive, however, is that changes to improve efficiency and precision of trenching can be made in the field on the job site, without replacing the chain 33, an advantage that, so far as is known, is not possible with conventional trenchers.

Although described in terms of the embodiments shown in the figures, these embodiments are shown to exemplify the present invention and not to limit the scope of the invention, it being recognized by those skilled in the art that certain changes can be made to the specific structure of the embodiments shown and described without departing from the spirit of the present invention. For instance, as noted above, the number of links comprising each set of the links of endless chain 33 may be different than eleven links; sets of eleven links are shown and described herein to exemplify the presently preferred embodiment of this invention. Similarly, the angles described herein are set out as ranges because those skilled in the art will recognize that even if the efficiency of trenching operations may be slightly decreased and/or wear and tear on the cutting chain may be slightly increased by using an angle other than the precise angle described herein as being preferred, the link and chain, and the mount of the cutting tooth to the link described herein is such that the chain would still offer advantages over known endless chains. The present invention also contemplates the mounting of cutting teeth to the links described herein utilizing a conventional mount that is welded to the upper surface of the link as known in the art, but where the mount is welded to the angled, upper surface 124 of each link comprising the endless chain; the angled surface of the link confers such an advantage in cutting, or penetrating power upon a cutting tooth mounted on that surface that a link constructed in that manner is also considered to fall within the scope of the present invention. It is also expected that links that are triangularly-shaped in cross-section (rather than the pentagonally-shaped links described herein), or even provided with six, seven, or more sides, could be utilized to advantage in an endless chain as described herein as long as one of the sides is angled relative to the direction of movement of the links. All such modifications, and other modifications that do not depart from the spirit of the present invention, are intended to fall within the scope of the following claims.

What is claimed is:

1. A link for linking to a plurality of similar links to form an endless chain for a chain-milling device comprising:
a body having leading and trailing surfaces, each of said leading and trailing surfaces being provided with means for linking said body to the bodies of other similar links to form the endless chain of a chain-milling device, said body also being provided with an upper surface to which a cutting tooth is mounted and a lower surface having means formed therein for engaging the drive wheel of the chain-milling device for moving said body, and the bodies of the similar links to which said body in linked, around the chain-milling device;
said leading surface having up upper, angled portion; and
a cutting tooth mounted to the upper, angled portion of said leading surface.

2. The link of claim 1 wherein the upper, angled portion of said leading surface is angled at an angle of between about 100° and about 175° relative to the direction of movement of said body.

3. The link of claim 1 additionally comprising a bore located in the upper, angled portion of said leading surface and having said cutting tooth received therein.

4. The link of claim 3 wherein the upper, angled portion of said leading surface is provided with at least two bores for receiving cutting teeth therein.

5. The link of claim 4 wherein the bores in the upper, angled portion of said leading surface are oriented at different angles relative to each other and relative to the upper, angled portion of said leading surface.

6. The link of claim 5 wherein the bores in the upper, angled surface of said leading surface are oriented at different angles ranging between about 3° and about 15° off of perpendicular to the upper, angled portion of said leading surface.

7. The link of claim 1 wherein said cutting tooth is elongate and is mounted to said link with the longitudinal axis of said cutting tooth oriented at an angle slightly greater than 45° relative to the direction of movement of said body.

8. The link of claim 7 wherein the angle at which the longitudinal axis of said cutting tooth is mounted ranges between about 48° to about 67° relative to the direction of movement of said body.

9. The link of claim 1 wherein the lower surface of said body is provided with a flange for resisting the tendency of said body to move in a direction other than the direction of movement of said body.

10. A link for linking to a plurality of similar links to form an endless chain for a chain-milling device, each of the links comprising the endless chain having one or more cutting teeth mounted thereto, comprising a body having a substantially pentagonal cross-sectional shape, the point and the two arms of the pentagon forming a leading surface, the base of the pentagon forming a trailing surface, one side of the pentagon having means formed therein for engaging the drive wheel of the chain-milling device for moving said body, and the bodies of the links to which said body is linked, around the chain-milling device, and the other side and one of the arms of the pentagon forming a top surface for mounting a cutting tooth thereto.

11. The link of claim 10 wherein the arm of the pentagon that comprises the top surface of said body is angled at an angle of about 100° to about 175° relative to the direction of movement of said body around the chain-milling device.

12. The link of claim 10 additionally comprising a bore in the arm of the pentagon that comprises a portion of the top surface of said body for receiving the shank of a cutting tooth for mounting the cutting tooth to said body.

13. The link of claim 12 wherein the arm of the pentagon that comprises a portion of the top surface of said body is provided with two or more bores for receiving the shanks of respective cutting teeth therein.

14. The link of claim 13 wherein the bores in the arm of the pentagon that comprises a portion of the top surface of said body are angled at different angles relative to the top surface of said body.

15. An endless chain formed by pivotally linking a plurality of the links of claim 10.

16. An endless chain for a chain-milling device comprising a plurality of sets of links, each link comprising said set of links being linked to an adjacent link, the top surface of each link being comprised of a surface oriented at an angle relative to the direction of movement of the endless chain when mounted on a chain-milling device, at least two of the links comprising each set of links having four bores on the angled surface thereof for receiving a cutting tooth therein, at least one of the links comprising each set of links having four bores spaced approximately equidistant across the angled surface thereof for receiving a cutting tooth therein, at least two of the links comprising each set of links having three bores on the angled surface thereof for receiving a cutting tooth therein, at least one of the links comprising each set of links having three bores on the angled surface thereof with two of the bores being proximate the ends of the links and oriented at an angle extending outwardly therefrom for receiving a cutting tooth therein, at least two of the links comprising each set of links having two bores on the angled surface thereof for receiving a cutting tooth therein, and at least one of the links comprising each set of links having two bores spaced approximately equidistant across the angled surface thereof for receiving a cutting tooth therein.

17. An endless chain for a chain-milling device comprising a plurality of sets of eleven links, each link comprising said eleven sets of links being pivotally linked to an adjacent link to form an endless chain for movement around the chain-milling device, each set of eleven links being comprised of:
at least two A links, each A link having four bores on the angled surface thereof for receiving a cutting tooth therein;
at least one B link having four bores spaced approximately equidistant across the angled surface thereof for receiving a cutting tooth therein;
at least two C links, each C link having three bores on the angled surface thereof for receiving a cutting tooth therein;
at least one D link having three bores on the angled surface thereof, two of the bores being proximate the ends of the D link and oriented at an angle extending outwardly therefrom, for receiving a cutting tooth therein;
at least two E links, each E link having two bores on the angled surface thereof for receiving a cutting tooth therein; and
at least one F link having two bores spaced approximately equidistant across the angled surface thereof for receiving a cutting tooth therein.

18. The endless chain of claim 17 wherein the bores in each link are angled relative to the direction of movement at an angle ranging from about 48° to about 67°.

19. The endless chain of claim 17 wherein the top surface of each of the A, B, C, D, E, and F links is provided with a surface oriented at an angle relative to the direction of movement.

20. The endless chain of claim 19 wherein the angled surface of each link is angled at an angle ranging from about 100° to about 175° relative to the direction of movement.

21. A method of maximizing the efficiency of cutting operations of a chain-milling device comprised of an endless chain having cutting teeth mounted to one or more of the links comprising the endless chain that is rotated around the chain-milling device by an engine comprising the steps of:
stopping the rotation of the endless chain around the chain-milling device;
either adding or subtracting cutting teeth by inserting or removing cutting teeth from bores in the links comprising the endless chain to without removing the endless chain from the chain-milling device; and
after adding or removing cutting teeth from the endless chain, again rotating the endless chain around the chain-milling device.

22. The method of claim 21 wherein the engine that rotates the endless chain around the chain-milling device is horsepower rated and the number of teeth that are either added or removed from the endless chain does not exceed the number that increases the ratio of the horsepower of the engine to the number of teeth above a range of from about 45 to 1 (horsepower to each tooth) to about 100 to 1.

23. The method of claim 21 wherein the endless chain is rotated around the chain-milling device at a speed of between about 400 and about 500 feet per minute.
